(19) United States
(12) Patent Application Publication
(10) Pub. No.: US 2007/0068858 A1
(43) Pub. Date: Mar. 29, 2007

(54) Aquarium cleaning device

(76) Inventor: Race A. Davison, Bonner Springs, KS (US)

Correspondence Address: CHASE LAW FIRM L.C, 4400 COLLEGE BOULEVARD, SUITE 130, OVERLAND PARK, KS, 66211, US

(21) Appl. No.: 11/235,015

(22) Filed: Sep. 26, 2005

(51) Int. Cl. A01K 63/04

(52) U.S. Cl. 210/167.23; 119/264

(57) ABSTRACT

A combination aquarium and cleaning apparatus for separating sediment from an aquarium tank, the tank having at least one sidewall supported by a bottom and adapted for holding water, aggregate and sediment intermixed within. The cleaning apparatus including a pump connected to a submersed separator unit by a flexible conduit at a first and a second end, the submersed separator unit being adapted for removing sediment from the tank. The separator unit, including a separation chamber and a separation capsule adapted for separating an aqueous mixture, the sediment and fluid mixture being separated from the aggregate, the sediment being generally removed from the fluid wherein the sediment is removed from the aquarium tank.

### FIELD OF THE INVENTION

The present invention relates generally to household aquariums and more particularly to an aquarium device for use in cleaning a fishtank aquarium having solids settled in the bottom thereof.

### BACKGROUND OF THE INVENTION

Aquariums have enjoyed increased popularity for both home and office use. Such aquariums typically hold fish, crustaceans or other amphibian life and may include a layer of aggregate or the like in the bottom of the aquarium tank which may be colored to further enhance the visual appearance of the tank.

After prolonged use of the aquarium, waste or other impurities may accumulate in the aquarium water. The impurities may settle in with the aggregate at the bottom of the aquarium which may diminuish the appearance of the aquarium which needs to be cleaned. However, the cleaning of the aquarium may be complicated by the presence of the amphibian life contained within the tank. Some current filtering devices, allow for the cleaning of the tank with manual means, the tank water being siphoned off and new tank water being added to the tank. This new tank water, however, must be conditioned before it can be used. It would therefore be beneficial to have a cleaning apparatus which allows the continued use of the contained water, the cleaning apparatus separating the impurities from the tank water without the addition of chemicals.

In addition, the cleaning of the aquarium tank with some cleaning apparatus may be complex and difficult to use, the cleaning apparatus being bulky, requiring additional support and multiple hands to operate. It would therefore be beneficial to have a simple cleaning apparatus which was convenient and simple to use for cleaning the aquarium tank.

### SUMMARY OF THE INVENTION

The present invention provides a combination aquarium and cleaning apparatus for separating sediment from an aquarium tank, the tank having at least one sidewall supported by a bottom and adapted for holding fluid, aggregate and sediment intermixed within. The cleaning apparatus includes a pump connected to one end of a conduit while another end of the conduit is connected to a submersed separator unit adapted for separating the sediment from the interior of the aquarium tank. The separator unit, including a separation chamber and a separation capsule, the capsule and chamber being adapted for separating an aqueous mixture of sediment and fluid from the aggregate, the sediment being generally removed from the fluid by the separation capsule, allowing the fluid to pass through the cleaning apparatus to an outlet discharge of the pump, back into the tank.

### BRIEF DESCRIPTION OF THE DRAWINGS

The drawings constitute a part of this invention and include exemplary embodiments of the present invention illustrating various objects and features thereof.

FIG. 1 is a rear perspective view of a combination aquarium tank and cleaning apparatus in combination with an aquarium in accordance with an embodiment of the present invention.

FIG. 2 is an exploded front perspective view of the aquarium cleaning apparatus.

FIG. 3 is a perspective view of the aquarium cleaning device.

FIG. 4 is a perspective view of an separation capsule device for use by the aquarium cleaning apparatus.

FIG. 5 is an exploded perspective view of the separation capsule for use by the aquarium cleaning apparatus.

FIG. 6 is a perspective view of an alternative embodiment of the aquarium cleaning apparatus.

### DETAILED DESCRIPTION

I. Introduction.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

II. Aquarium Tank and Cleaning Apparatus.

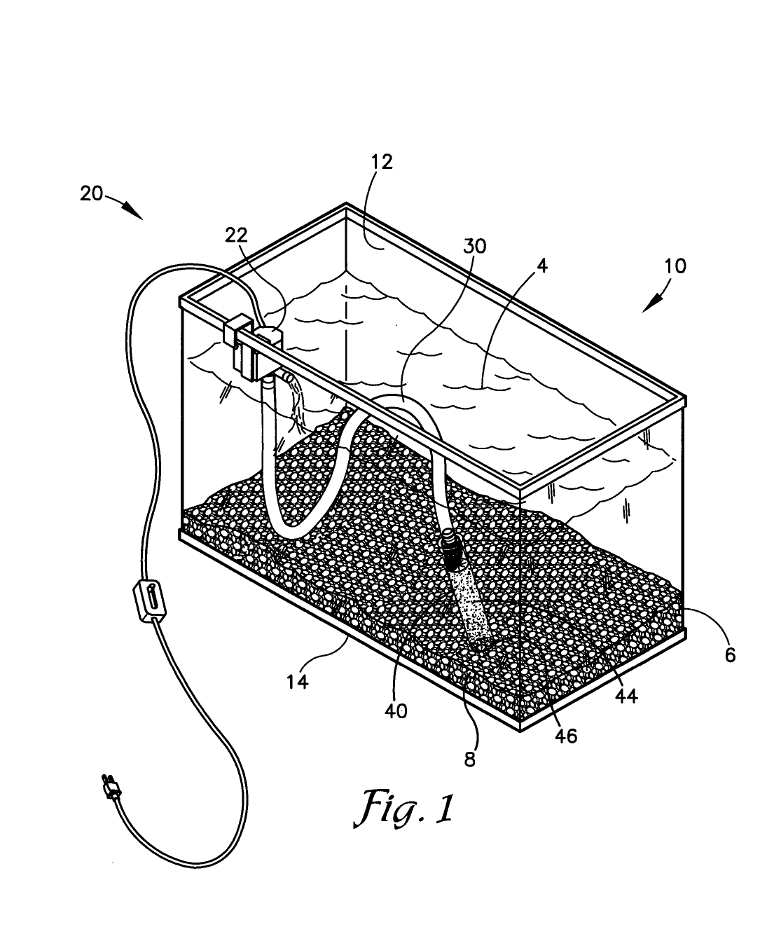

Referring to FIG. 1, an embodiment of the present invention a cleaning apparatus, in combination with an aquarium tank, the cleaning apparatus being generally indicated by reference numeral 20 while the aquarium tank is generally indicated by reference numeral 10. The cleaning apparatus 20 is associated with the aquarium tank 10 having at least one tank sidewall 12 supported by a tank bottom 14 enclosing a water or other liquid 4 with an aggregate material 6 located beneath the surface of the water 4, the aggregate 6 being generally intermingled with a stored sediment 8. The cleaning apparatus 20 generally includes a pump 22 with a conduit 30 extending to a submersed separator unit 40 located beneath the water 4 surface near the aggregate 6 for separating the aggregate 6 from the sediment 8. The mixture of the aggregate 6, sediment 8 and tank fluid 4 provides an aqueous mixture stored within the tank 10. In use, the separator unit 40 is submersed within the water 4, an open end 46 directed towards the sediment 8 intermixed with the aggregate 6. As the pump 22 operates, the water 4 is communicated through a separator chamber 44 to the conduit 30 and then to the pump 22. At the chamber 44 open end 46, the sediment 8 is separated from the aggregate 6, the sediment 8 passing at least partly through the separator unit 40 while the generally denser aggregate falls back onto the surrounding aggregate material 6.

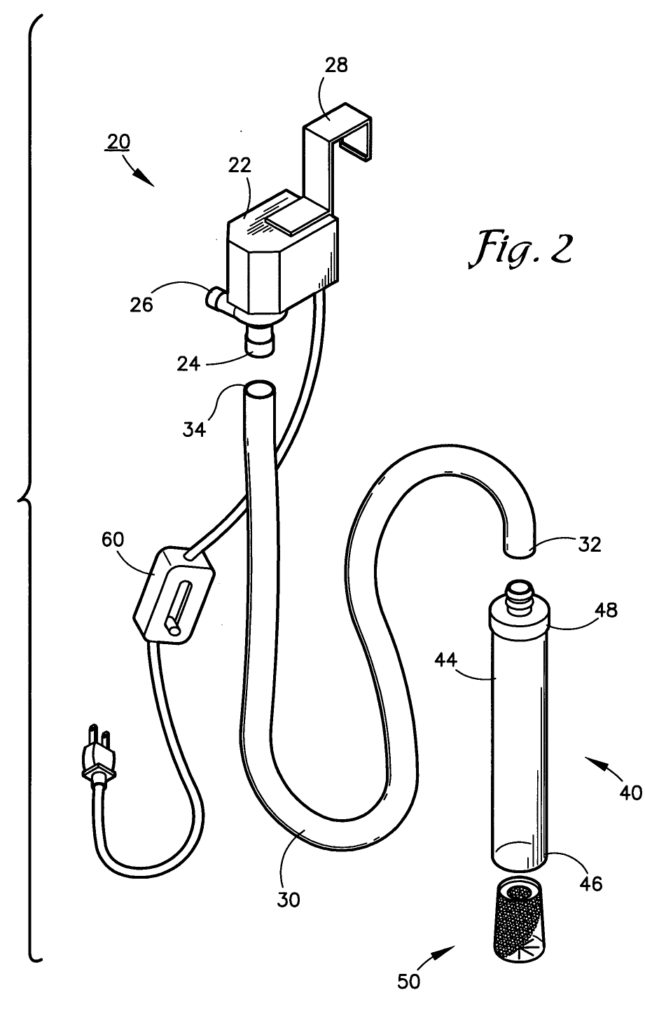

FIG. 2 illustrates the cleaning apparatus 20 with various elements separated from each other to help illustrate the apparatus 20. As illustrated the pump 22 inlet 24 is adapted for receiving the second end 34 of the flexible conduit 30. The first end 32 of the flexible conduit 30 is received by an end of the submersible separator unit 40 for fluidic communication of the tank fluid 4 through the cleaning apparatus 20 and back into the tank 10 from the outlet discharge 26 of the submersible pump 22. The submersible pump is associated with the sidewall hanger 28 which is generally adapted to suspend the submersible pump 22 on the tank sidewall 12. While various pumps which may be utilized by one skilled in the art in connection with the present invention have different pumping characteristics, preferably, the pump 22 will be submersed within the tank fluid 4 during operation. The pump 22 also optionally includes an inline toggle switch 60 for selectively operating the cleaning apparatus 20, the toggle switch 60 being preferably a single-pole, single-throw switch adapted for one-handed operation of the cleaning apparatus 20.

The submersible separator unit 40 as illustrated in FIG. 2 includes the separator chamber 44 having two ends including an open end 46 adapted for receiving a separator capsule 50 adapted for separating the sediment 8 from the water 4 passing therethrough. The other end of the separator chamber 44, opposite the open end 46, presents a connector 48 operably connected to said conduit first end 32, the connector 48 preferably sealing the unit 40 to the conduit 30, the separator unit 40 being in fluidic communication with the inlet 24 of the pump 22.

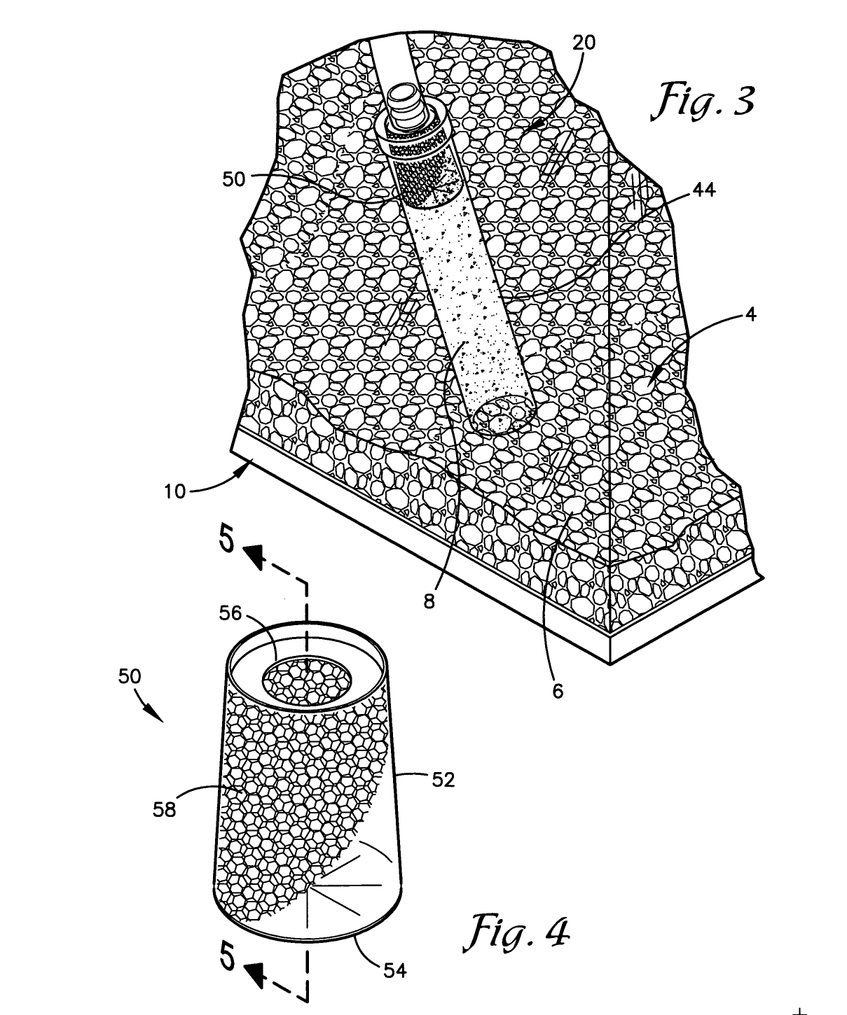

In operation as illustrated in FIG. 3 the separator unit 40 receives the separator capsule 50 through the open end 46 of the separator chamber 44. While the separator unit 40 is submersed, the open end 46 is directed towards the sediment 8, aggregate 6 mixture. The pump 22, when operated, directs the separator capsule 50 towards the connector 48, opposite the chamber open end 46. The aqueous mixture is also drawn into the open end 46 of the separator chamber 44. Although a number of different pumps may be utilized in the present invention, preferably, the pump 22 is configured to operate in connection with a standard household outlet with pumping characteristics compatible with the average density of the aggregate 6 located within the tank 10, the aggregate 6 preferably falling back into the tank 10, the aggregate being preferably separated from the sediment 8 at the separation chamber 44. As the cleaning apparatus 20 continues to operate, the aqueous mixture including the sediment 8 is further drawn into the separation chamber 44 towards the separator capsule 50. The aqueous mixture, being transmitted from the separation chamber 44 to the pump 22, is drawn through the separator capsule 50, the sediment 8 being generally restrained by the capsule 50, the fluid 4 traveling on through the apparatus 20 to the pump discharge outlet 26 upon which the generally sediment deficient fluid is returned to the tank 10.

FIG. 4 illustrates the separator capsule 50 including an outer permeable layer 52 permitting the transmission of fluid through an inner porous member 58 which is adapted to separate the sediment 8 from the aqueous mixture passed through the separator chamber 44. Although the outer permeable layer 52 is illustrated with a permeable inlet 54 having a star configuration and an outlet 56 configured with an annular aperture separated by the inner porous member 58, the inlet 54 and outlet 56 may have various configurations which are known by one skilled in the art to allow for separation of the sediment 8 while permitting the transmission of fluid therethrough

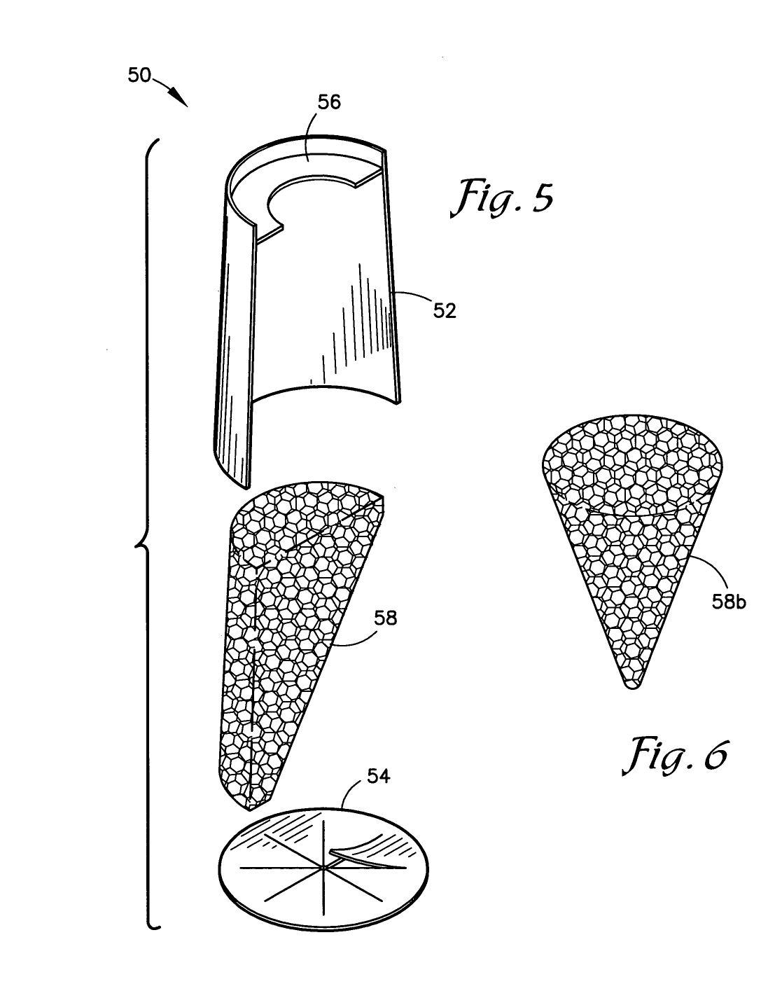

FIG. 5 illustrates an exploded view of the separator capsule 50, in which the inner porous member 58 is removed from the outer permeable layer 52, the inner porous member 58 being shown having a cellular structure, preferably overlapping and adapted for separating the sediment 8 from the aqueous mixture. Examples of porous cellular structures may include a paper filter, woven and unwoven fibers, glass or ceramic materials or permeable plastic materials having an overlapping structure for creating a barrier for the transmission of sediment 8 through the cleaning apparatus 20. The inner porous member 58 illustrated in FIG. 5 is configured having a bisected frustoconical shape with a top and a bottom, the top adapted for receiving the aqueous mixture in an angular orientation, the bottom being generally adapted for obstructing the annular outlet 56 and creating a barrier to the sediment 8 contained with the aqueous mixture, the porous member 58 separating the sediment 8 from the aqueous mixture before fluidic communication to the pump 22 after the fluid 4 exits the separator capsule 50. The inlet 54 is also illustrated as having a star configuration optionally constructed from a flexible rubberized material. However, alternative configuration of the inlet 54 may be provided for the transmission of the aqueous mixture through the separator capsule 50. The inner porous member 58 may also have alternative shapes including but not limited to the porous member 58b illustrated in FIG. 6 with a generally conical shape.

It will be appreciated that various other configurations and embodiments may fall within the scope of the present invention. While certain forms of the present invention have been illustrated and described herein, it is not to be limited to the specific forms or arrangement of parts described and shown.

Having thus described the invention, what is claimed as new and desired to be secured by Letters Patent is as follows:

1. A combination aquarium tank and cleaning apparatus for separating and removing sediment from an aquarium tank formed by at least one sidewall supported by a bottom, the tank containing water, aggregate and sediment intermixed therein, said cleaning apparatus comprising:
a pump having an inlet and an outlet discharge, said discharge returning the water to the aquarium tank,
a conduit having a first end and a second end, said second end connected to said inlet,
a submersed separator unit in fluidic communication with said inlet of said pump, said separator unit adapted for removing the sediment from the aquarium tank
a separation chamber associated with said separator unit, said chamber operably connected to said first end and adapted for filtering the aggregate from the sediment passing therethrough, and
a separator capsule releasably secured by said separation chamber and adapted for filtering the sediment from the water passing therethrough.

2. The cleaning apparatus according to claim 1 wherein said pump is submersible for operation within the water.

3. The cleaning apparatus according to claim 1, further comprising a sidewall hanger adapted for mounting said pump on the sidewall.

4. The cleaning apparatus according to claim 1, wherein said conduit is flexible for flexibly communicating the water from said separation chamber to said pump.

5. The cleaning apparatus according to claim 1 wherein said separator capsule further comprises:
an outer permeable layer adapted for transmitting the water therethrough, and
an inner porous member for separating the sediment from the water.

6. The cleaning apparatus according to claim 5 wherein said outer permeable layer has a star inlet and an annular outlet, said inlet in fluidic communication with said outlet for the transmission of the water.

7. The cleaning apparatus according to claim 6 wherein said inner porous member is a bisected frustoconical porous member adapted for overlying said annular outlet.

8. The cleaning apparatus according to claim 1 further comprising a single through, single pole switch electronically connected to said pump for operating said pump.
